(19) United States
(12) Patent Application Publication
(10) Pub. No.: US 2025/0199773 A1
(43) Pub. Date: Jun. 19, 2025

(54) Software design pattern for achieving clean multiple inheritance in Object Oriented Programming

(71) Applicant: YuQian Zhou, MERCER ISLAND, WA (US)

(72) Inventor: YuQian Zhou, MERCER ISLAND, WA (US)

(73) Assignee: YuQian Zhou, Mercer Island, WA (US)

(21) Appl. No.: 18/537,810

(22) Filed: Dec. 13, 2023

(51) Int. Cl. G06F 8/20; G06F 8/30

(52) U.S. Cl. CPC G06F 8/24; G06F 8/315

(57) ABSTRACT

A design pattern called DDIFI (stands for Decoupling Data Interface From data Implementation) is described, which cleanly solved the diamond problem in multiple inheritance of object oriented programming. It can handle the class fields exactly according to the programmer's intended application semantics, providing flexibility: each instance variable can be configured individually either as one joined copy or as multiple independent copies in the implementation class. The key points are:
(1) decouple data interface from data implementation, by stopping inheriting data fields;
(2) in the regular methods implementation use virtual property methods instead of direct raw fields; and
(3) after each semantic branching add (and override) the new semantic assigning property.

This method is general enough, and can achieve clean multiple inheritance in any OOP languages that:
native-ly support multiple inheritance (e.g. C++, Python, OCaml, Lisp, Eiffel, etc.)
single inheritance languages that support default interface methods (e.g. Java, C # etc.)
single inheritance languages that support mixins (e.g. D), or traits (e.g. Scala etc).

### CROSS-REFERENCE TO RELATED APPLICATIONS

This application claims the priority benefit of U.S. provisional application 63/487,074, titled “Decoupling data interface from data implementation as a clean and general solution to multiple inheritance of object oriented programming” filed Feb. 27, 2023, the disclosures of which are incorporated herein by reference.

### BACKGROUND OF THE INVENTION

The most difficult challenge in multiple inheritance (MI) is exemplified by the well-known “diamond problem”, leading to MI's avoidance in most contemporary Object Oriented Programming (OOP) languages, such as Java, C #, and Scala etc., which primarily advocate for single inheritance. Nevertheless, to address the absence of MI while maximizing code reuse, alternative techniques such as object composition, mixins/traits have been employed. However, these existing approaches have fallen short in effectively resolving naming conflicts, especially for inherited fields conflicts. In particular, they have not provided a satisfactory mechanism for programmers to specify, on an individual basis, how each inherited field should be joined or separated.

### SUMMARY OF THE INVENTION

The present invention provides a method for designing object-oriented Software for achieving clean multiple inheritance. It can handle the class fields of the multiple inheritance exactly according to the programmer's intended application semantics. It gives programmers flexibility when dealing with the diamond problem for instance variables: each instance variable can be configured individually either as one joined copy or as multiple independent copies in the implementation class. The key points are:
(1) decouple data interface from data implementation, by stopping inheriting data fields;
(2) in the regular methods implementation use virtual property methods instead of direct raw fields; and
(3) after each semantic branching add (and override) the new semantic assigning property.
   The method of the present invention is general enough, and can achieve clean multiple inheritance in any OOP languages:
that natively support multiple inheritance (e.g. C++, Python, OCaml, Lisp, Eiffel, etc.)
single inheritance languages that support default interface methods (e.g. Java, C #etc.)
single inheritance languages that support mixins (e.g. D), or traits (e.g. Scala)

### BRIEF DESCRIPTION OF DRAWINGS

The present invention is illustrated by way of example, and not by way of limitation, in the figures of the accompanying drawings and in which like reference numerals refer to similar elements and in which:

FIG. 1: is a class UML diagram that illustrates the diamond problem in multiple inheritance.

FIG. 2: is a class UML diagram that further illustrates the diamond problem using an example of <Person, Student, Faculty, and ResearchAssistant>: the ideal semantics of fields ‘name’ & ‘addr’, which is not achievable in C++'s plain MI mechanism: with ‘name’ joined into one field, and ‘addr’ separated into two fields.

FIG. 3: is a class UML diagram that illustrates our method DDIFI decouples data interface (class Person with abstract property methods) from data implementation (class PersonImpl where the fields and property methods are actually defined).

FIG. 4: is a class UML diagram that illustrates our method DDIFI achieved the ideal semantics of fields name & addr: with name joined into one field, and addr separated into two fields.

### DETAILED DESCRIPTION OF THE INVENTION

In the following description, for the purposes of explanation, numerous specific details are set forth in order to provide a thorough understanding of the present invention. It will be apparent, however, that the present invention may be practiced without these specific details.

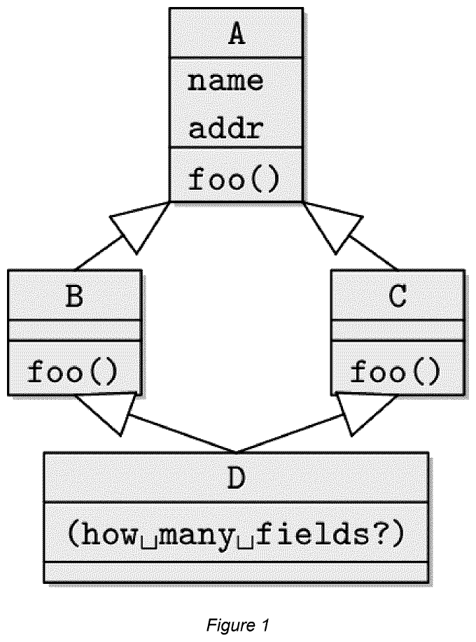

The most well known problem in multiple inheritance (MI) is the diamond problem [Snyder 1987] [Knudsen 1988] [Sakkinen 1989], for example on the popular website wikipedia (for everyday working programmers) it is described as: The “diamond problem” is an ambiguity that arises when two classes B and C inherit from A, and class D inherits from both B and C. If there is a method in A that B and C have overridden, and D does not override it, then which version of the method does D inherit: that of B, or that of C? (as shown in FIG. 1).

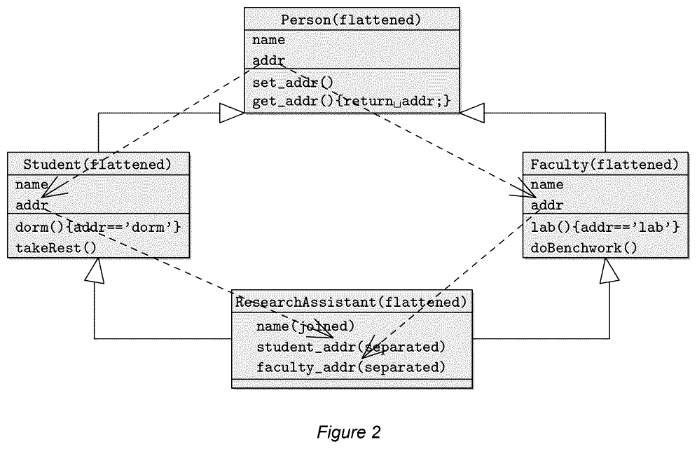

Actually in the real world engineering practice, for any method's ambiguity e.g. foo( ), it is relatively easy to resolve by the programmers:
just override it in D.foo( ), or
explicitly use fully quantified method names, e.g. A.foo( ), B.foo( ), or C.foo( ).
   The more difficult problem is how to handle the data members (i.e. fields) inherited from A:
(1) Shall D have one joined copy of A's fields? or
(2) Shall D have two separate copies of A's fields? or
(3) Shall D have mixed fields from A, with some fields being joined, and others separated?
   For example, in C++ [Stroustrup 1989] [Stroustrup 1994], [Stroustrup 2003] (1) is called virtual inheritance, and (2) is default (regular) inheritance. But C++ does not completely solve this problem, it is difficult to achieve (3). This is the main problem that we solved with our method. Suppose we want to build an object model for Person, Student, Faculty, and ResearchAssistant in a university (as shown in FIG. 2): We would like to formulate this ResearchAssistant inheritance problem as: Problem 1 (The intended application semantics). In the diamond inheritance of <Person, Student, Faculty, ResearchAssistant>, a ResearchAssistant should have
only 1 name field,
but 2 different address fields: (1) one “dorm” as Student to takeRest( ), and
(2) one “lab” as Faculty to doBenchwork( ) so in total 3 fields.
   In the following we will use this problem as the working example to illustrate our method to simultaneously achieve both the field joining and separation in multiple inheritance, just as the dining philosophers problem as the working example in concurrency algorithm design.

LITERATURE SURVEY AND CURRENT ENGINEERING PRACTICES. In C++'s plain MI we can do either:
(1) virtual inheritance: ResearchAssistant will have 1 name, and 1 addr; in total 2 fields, or
(2) default inheritance: ResearchAssistant will have 2 names, and 2 addrs; in total 4 fields
   It is difficult to achieve the intended application semantics. As is shown in the following C++ code:

```
// plain_mi.cpp
#include <iostream>
#include <string>
typedef std::string String;
#define VIRTUAL // virtual // no matter we use virtual inheritance or not, it's problematic
class Person {
protected:
  String _name; // need to be joined into one single field in ResearchAssistant
  String _addr; // need to be separated into two addresses in ResearchAssistant
public:
  virtual String name( ) {return _name;}
  virtual String addr( ) {return _addr;}
};
class Student : public VIRTUAL Person {
public:
  virtual String dorm( ) {return _addr;} // assign dorm semantics to _addr
  void takeRest( ) {
    std::cout << name( ) << “ takeRest in the ” << dorm( ) << std::endl;
  }
};
class Faculty : public VIRTUAL Person {
public:
  virtual String lab( ) {return _addr;} // assign lab semantics to _addr
  void doBenchwork( ) {
    std::cout << name( ) << “ doBenchwork in the ” << lab( ) << std::endl;
  }
};
class ResearchAssistant : public VIRTUAL Student, public VIRTUAL Faculty {
};
int main( ) {
  std::cout << “sizeof(Person) = ” << sizeof(Person) << std::endl;
  std::cout << “sizeof(Student) = ” << sizeof(Student) << std::endl;
  std::cout << “sizeof(Faculty) = ” << sizeof(Faculty) << std::endl;
  std::cout << “sizeof(ResearchAssistant) = ” << sizeof(ResearchAssistant) << std::endl;
}
```

Hence if the programmers use C++'s multiple inheritance mechanism plainly as it is, ResearchAssistant will have either one whole copy, or two whole copies of Person's all data members. This leaves something better to be desired. E.g this is why the Google C++ Style Guide [Google 2022] (last updated: Jul. 5, 2022) gives the following negative advice about the diamond problem in MI:
Multiple inheritance is especially problematic, . . . because it risks leading to “diamond” inheritance patterns, which are prone to ambiguity, confusion, and outright bugs.
Because the C++ inheritance mechanism (virtual or not) always treat all the fields from the super-class as a whole, no matter how to combine virtual and non-virtual inheritance in any possible way, it will not achieve the goal what we want: i.e. support both field join and separation flexibly according to any application semantics the programmers needed.
Moreover, [Wasserrab et al. 2006] presented an operational semantics and type safety proof for multiple inheritance in C++, and they concluded the combination of virtual and non-virtual inheritance caused additional complexity at the semantics level.

Other OOP languages have designed different mechanisms, among the most popular OOP languages (besides C++) used in the industry:
In Python [Van Rossum and Drake Jr 2014] all the inherited fields are joined by name (a Python object's fields are keys of an internal dictionary), hence there is no direct language inheritance mechanism to achieve fields separation.
Java [Gosling et al. 2000] and C # [Hejlsberg et al. 2003] get rid of multiple inheritance in favor of the simple single inheritance and multiple interfaces, and advise programmers to use composition to simulate multiple inheritance when needed.

In Python [van Rossum 2010] and many other OOP languages, method resolution order (MRO) [Barrett et al. 1996] imposes the same order to all features, which is less flexible since it is hard to select each inherited feature individually: the base classes' order in the inheritance clause should not matter.

Multiple inheritance via composition: For OOP languages which do not directly support multiple inheritance, it is usually suggested to simulate multiple inheritance via composition. As illustrated in the following:

```
// multiple inheritance via composition
class ResearchAssistant implements Studentl, Facultyl { // suffix ′I′ means Interface
  Student _theStudentSubObject; // composition
  Faculty _theFacultySubObject; // composition
  // Problem 1, code duplication: manual forwarding for *every* methods is very tedious
  void doBenchWork( ) { _theFacultySubObject.doBenchWork( ); }
  void takeRest( ) { _theStudentSubObject.takeRest( ); }
  String lab( ) { return _theFacultySubObject._addr; }
  String dorm( ) { return _theStudentSubObject._addr; }
  // Problem 2, data duplication: need mutex, and keep *multiple duplicate* fields in sync
  Object set_name_mtx; // need extra mutex var
  String name( ) {
    synchronized (set_name_mtx) {
      String r = _theStudentSubObject._name;
      return r;
    }
  }
  String name(String name) {
    synchronized (set_name_mtx) {
      _theStudentSubObject._name = name; // dup fields
      _theFacultySubObject._name = name;
    }
  }
};
```

First, logically speaking we think this method is abusing “Has-A” relationship as “Is-A” relationship. (i.e. a ResearchAssistant “Is-A” both Student and Faculty object, not “Has-A” both Student and Faculty objects).
Furthermore, with manual method forwarding, which is not only very tedious, but also incur data duplication, e.g.
Each ResearchAssistant object will contain both a Student and Faculty sub-object, so the fields name are duplicated in both the sub-objects.
In multi-threaded environment, assign new value to the two name fields in these two sub-objects need to be protected by a synchronization lock, which increases the complexity of the software.

Mixins/traits: In some other single inheritance OOP languages, various forms of mixins are introduced to remedy the lack of MI. Informally a mixin/trait is a named compilation unit which contains fields and methods to be “inlined (copy/pasted)” rather than inherited by the client class to avoid the inheritance relationship, e.g.:
Mixins [Bracha and Cook 1990] in Dart, D [Bright et al. 2020], Ruby [Flanagan and Matsumoto 2008], etc.
Traits [Schärli et al. 2003] [Ducasse et al. 2006] in Scala [Odersky 2010], PHP [Lockhart 2015], Pharo Language [Tesone et al. 2020], Hack [Ottoni 2018] etc.
   However, the problems with mixins and traits are:
(1) There is no clean and flexible way to resolve field (of the same name) conflicts included from multiple different mixins, this is what our method has achieved.
(2) Furthermore, an object of the type of the including class cannot be cast to, and be used as the named mixin type, which means it paid the price of the inheritance ambiguity of (e.g. as C++'s plain) MI, but does not enjoy the benefit of it.

### Decoupling Data Interface from Data Implementation

One of the most important OOP concepts is encapsulation, which means bundling data and methods that work on that data within one unit (i.e. class). As noted, inherited method conflicts are relatively easy to solve by the programmers by either overriding or using fully quantified names in the derived class.

Troublemaker: the inherited fields But for fields, traditionally in almost all OOP languages, if a base class has field f, then the derived class will also have this field f. The reason that the inherited data members (fields) from the base classes causing so much troubles in MI is because fields are the actual memory implementations, which are hard to be adapted to the new derived class, e.g.:
Should the memory layouts of all the different base classes' fields be kept intact in the derived class? and in which (linear memory) order?
How to handle if the programmers want some of the inherited fields from different base classes to be merged into one field (e.g. name in the above example), and others separated (e.g. addr in the above example) according to the application semantics?
What are the proper rules to handle all the combinations of these scenarios? The key inspiring question: since class fields are the troublemakers for MI, can we just remove them from the inheritance relation? or delay their implementation to the last point?

The key idea: reduce the data dependency on fields to methods dependency on properties Let us step back, and check what is the minimal dependency of the class methods on the class data? Normally there are two ways for a method to read/write class fields:
(1) directly read/write the raw fields
(2) read/write through the getter/setter methods
   Definition 1 (getter and setter method). In OOP we have.
The getter method returns the value of a class field.
The setter method takes a parameter and assigns it to a class field.
   In the following, we call getter and setter as property method or just property; and we call the collection of properties of a class as the data interface of the class; In contrast we call the other non-property class methods as regular methods or just methods. In FIG. 2 and plain_mi.cpp, we can see the field Person._addr has been assigned two different meanings in the two different inheritance branches: in class Student it's assigned “dorm” semantics, while in class Faculty it's assigned “lab” semantics.

Definition 2 (semantic branching site of property). If a class C's property p has more than one semantic meanings in its immediate sub-classes, we call C the semantic branching site of p; If class A inherits from class B, we call A is below B.

In our previous example, class Person is the semantic branching site of property addr; and class Student is below Person. Since properties are methods which are more manipulatable than the raw fields, we can reduce the data dependency on fields to methods dependency on properties, by only using fields' getter and setter in the regular methods.

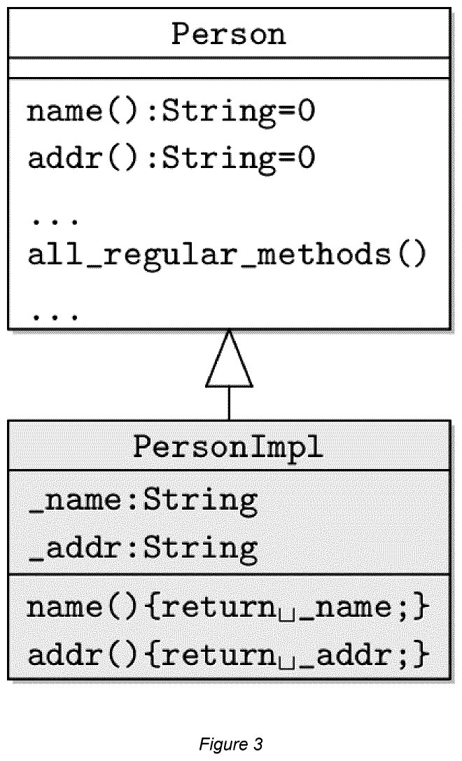

Traditionally, the getter and setter methods are defined in the same scope as the field is in, i.e. in the same class body (as we can see from the class Person in plain_mi.cpp of the previous example). But due to the troubles the class fields caused us in MI, we would like to isolate them into another scope (as data implementation). Then to make other regular methods in the original class continue to work, we will add abstract property definitions to the original class (as data interface). For example, as shown in the class UML diagram in FIG. 3.

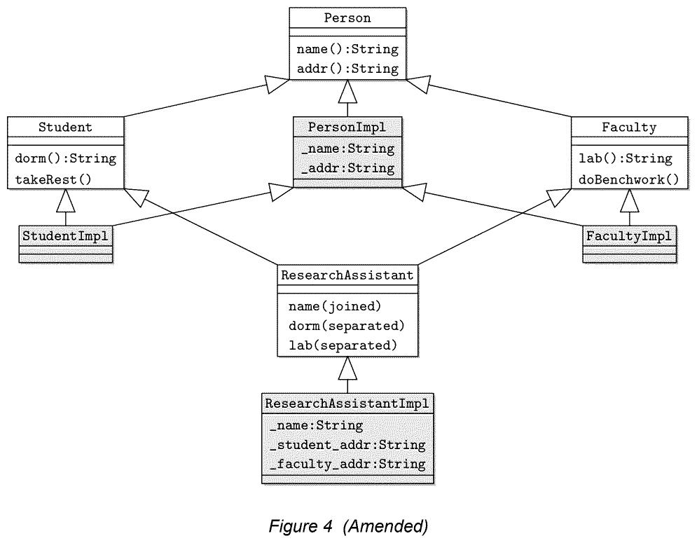

The key point here is that: the programmers have the freedom to either add new or override existing property methods in the derived class' data interface to achieve any application semantics, without worrying about the data implementation, which will be eventually defined in the implementation class. Thus remove the data dependency of the derived class' implementation on the base classes' implementation. The UML of our DDIFI classes are shown in FIG. 4.

Please note: implementation inheritance is still an option, e.g. Studentimpl inherits PersonImpl, and FacultyImpl inherits PersonImpl for maximal code reuse; but it is not mandatory, e.g. ResearchAssistantImpl is totally independent of Studentimpl, FacultyImpl, and PersonImpl.

In the following we will demo how this data interface and implementation decoupling can solve the diamond problem in a clean way with concrete C++ code.

### person.h

```
// person.h
// define abstract virtual property, in Person's data-interface
class Person {
public:
  virtual String name( ) = 0; // C++ abstract virtual method
  virtual String addr( ) = 0; // C++ abstract virtual method
  // all_public_or_protected_regular_methods( ) are defined in the data-interface
  // to be inherited and code-reused
};
// define fields and property method, in Person's data-implementation
class Personlmpl : Person {
protected:
  String _name;
  String _addr;
public:
  virtual String addr( ) override { return _addr; }
  virtual String name( ) override { return _name; }
};
```

First, split person.h into two classes: Person as data interface (with regular methods), and move fields definition into Personimpl as data implementation.

### student.h

```
// student.h
class Student : public Person {
public:
  // add new semantic assigning virtual property
  virtual String dorm( ) { // give it a new exact name matching its new semantics
    return addr( ); // but the implementation here can be just super's addr( )
  }
  // regular methods' implementation
  void takeRest( ) {
    cout << name( ) << “ takeRest in the ”
        << dorm( ) // MUST use the new property, not the inherited addr( ) whose semantics has
branched!
        << endl;
  }
};
class Studentlmpl : public Student, Personlmpl {
  // no new field: be memory-wise efficient, while function-wise flexible
};
```

We do the same for student.h, please also note:
(1) We added a new semantic assigning virtual property dorm( ), which currently just return addr( ); but can be overridden in the derived classes.
(2) We implemented all other regular methods in the data-interface class Student, which when needed can read/write (but not direct access) any class field via the corresponding (abstract) property method.
(3) Please also take notice here Student.takeRest( ) calls dorm( ) (which in turn calls addr( )), instead of calling addr( ) directly. We will discuss this treatment of semantic branching property in the next section.
(4) Studentimpl inherits all the data fields from Personimpl, this is just for convenience; alternatively, the programmer can choose to let Studentimpl define its own data implementation totally independent of PersonImpl, as we will show in the following ResearchAssistantimpl. This is the key to solve the inherited field conflicts of the diamond problem.

### Listing 5. faculty.h

```
class Faculty : public Person {
public:
  // add new semantic assigning virtual property
  virtual String lab( ) { // give it a new exact name matching its new semantics
    return addr( ); // but the implementation here can be just super's addr( )
  }
  // regular methods' implementation
  void doBenchwork( ) {
    cout << name( ) << “ doBenchwork in the ”
        << lab( ) // MUST use the new property, not the inherited addr( ) whose semantics
has branched!
        << endl;
  }
};
class Facultylmpl : public Faculty, Personlmpl {
  // no new field: be memory-wise efficient, while function-wise flexible
};
```

We do the same also for faculty.h, and added a new semantic assigning property lab( ).

### Listing 6. ra.h

```
// ra.h
class ResearchAssistant : public Student, public Faculty { // MI with regular-methods
code reuse!
};
class ResearchAssistantlmpl : public ResearchAssistant { // only inherit from
ResearchAssistant interface
protected:
  // define three fields: NOTE: totally independent to those fields in
  // Personlmpl, Studentlmpl, and Facultylmpl
  String _name;
  String _faculty_addr;
  String _student_addr;
public:
  ResearchAssistantlmpl( ) { // the constructor
    _name = NAME;
    _faculty_addr = LAB;
    _student_addr = DORM;
  }
  // override the property methods
  virtual String name( ) override { return _name; }
  virtual String addr( ) override { return dorm( ); } // use dorm as ResearchAssistant's main
addr
  virtual String dorm( ) override { return _student_addr; )
  virtual String lab( ) override { return _faculty_addr; }
};
  ResearchAssistant* makeResearchAssistant( ) { // the factory method
  ResearchAssistant* ra = new ResearchAssistantlmpl( );
  return ra;
}
```

Finally, we define research assistant, please note:
(1) The fields of ResearchAssistantImpl: _name, _faculty_addr, and _student_addr are totally independent of the fields in PersonImpl, StudentImpl, and FacultyImpl. This is what we mean: removing the data dependency of the derived class' data implementation on the base classes' data implementations
(2) Now indeed each ResearchAssistant object has exactly 3 fields: 1 name, 2 addrs!
(3) We added a factory method to create new ResearchAssistant objects.

Let's create a ResearchAssistant object, also assign it to Faculty*, Student* variables, and make some calls of the corresponding methods on them:

```
// application.cpp
#include <iostream>
#include <string>
typedef std::string String;
using namespace std;
String NAME = “ResAssis”;
String HOME = “home”;
String DORM = “dorm”;
String LAB = “lab”;
#include “person.h”
#include “student.h”
#include “faculty.h”
#include “ra.h”
#include “biora.h”
int main( )
  ResearchAssistant* ra = makeResearchAssistant( );
  Faculty* f = ra;
  Student* s = ra;
  ra->doBenchwork( ); // ResAssis doBenchwork in the lab
  ra->takeRest( ); // ResAssis takeRest in the dorm
  f->doBenchwork( ); // ResAssis doBenchwork in the lab
  s->takeRest( ); // ResAssis takeRest in the dorm
  return 0;
}
```

As we can see, all the methods generate expected correct outputs. To the best of the authors' knowledge, this design pattern that we introduced in this section to achieve multiple inheritance so cleanly has never been reported in any previous OOP literature. It is the first design pattern that cleanly solves the diamond problem in a number of mainstream industry-strength OOP programming languages, e.g. C++ [Stroustrup 1991], Java, C #, Python, Ocaml [Leroy et al. 2021], D, etc, which we will show in the following sections.

Virtual property: It is very important to define the property method as virtual, this gives the programmers the freedom to choose the appropriate implementation of the concrete representation in the derived class. Properties can be:
fields (data members) with memory allocation, or
methods via computation if needed.
   For example, a biology research assistant may alternate between two labs (labA, labB) every other weekday to give the micro-organism enough time to develop. We can implement BioResearchAssistantImpl as the following (please pay special attention to the new lab( ) property):

```
// biora.h
#include “util.h”
String LAB_A = “labA”;
String LAB_B = “labB”;
// only inherit from ResearchAssistant, but not from any other xxxlmpl class
class BioResearchAssistantlmpl : public ResearchAssistant {
protected:
  // define two fields: NOTE: totally independent to those fields in Personlmpl,
Studentlmpl, and Facultylmpl
  String _name;
  String _student_addr;
public:
  BioResearchAssistantlmpl( ) { // the constructor
    _name = NAME;
    _student_addr = DORM;
  }
  // override the property methods
  virtual String name( ) override { return _name; }
  virtual String addr( ) override { return dorm( ); } // use dorm as ResearchAssistant's main
addr
  virtual String dorm( ) override { return_student_addr; )
  virtual String lab( ) override {
    int weekday = get_week_day( );
    return (weekday % 2) ? LAB_A : LAB_B; // alternate between two labs
  }
};
ResearchAssistant* makeBioResearchAssistant( ) { // the factory method
  ResearchAssistant* ra = new BioResearchAssistantlmpl( );
  return ra;
}
```

Note: both ResearchAssistantImpl and BioResearchAssistantImpl are at the bottom point of the diamond inheritance, but their actual fields are quite different. In our approach the derived class data implementation does not inherit the actual fields from the base classes' data implementation, but only inherits the data interface of the base classes (i.e. the property methods, and will override them). This is the key difference from C++'s plain MI mechanism. That's why our approach is so flexible that it can achieve the intended semantics the programmers needed. In the next section we will summarize the new programming rules to formalize our approach to achieve general MI.

### New Programming Rules

Rule 1 (split data interface class and data implementation class). To model an object foo, define two classes:
(1) class Foo as data interface, which does not contain any field; and Foo can inherit multiple-ly from any other data-interfaces.
(2) class Foolmpl inherit from Foo, as data implementation, which contains fields (if any) and implement property methods.

For example, we can see from person.h and FIG. 3: class Person and PersonImpl in the previous section.

Rule 2 (data interface class). In the data-interface class Foo:
(1) define or override all the (abstract) properties, and always make them virtual (to facilitate future unplanned MI).
(2) implement all the (especially public and protected) regular methods, using the property methods when needed, as the default regular methods implementation.
(3) add a static (or global) Foo factory method to create Foolmpl object, which the client of Foo can call without exposing the FooImpl's implementation detail.
   Note: although Foo is called data interface, the regular methods are also implemented here, because:
it's good engineering practice to program to (the data) interfaces, instead of using the raw fields directly
other derived classes will inherit from Foo, (instead of Foolmpl which is data implementation specific), so these regular methods can be reused to achieve the other OOP goal: maximal code reuse.
   Of course, for the private regular methods, the programmer may choose to put them in Foolmpl to hide their implementation.

Rule 3 (data implementation class). In the data-implementation class FooImpl:
(1) implement all the properties in the class Foolmpl: a property can be either (a) via memory, define the field and implement the getter and setter, or (b) via computation, define property method
(2) implement at most the private regular methods (or just leave them in class Foo by the program to (the data) interfaces principle, instead of directly accessing the raw fields).
   So, because of Rule 2 all the data-interface classes (which also contains regular method implementations) can be multiple-ly inherited by the derived interface class without causing fields conflict. And because of Rule 3 each data-implementation class can provide the property implementations exactly as the intended application semantics required.

Rule 4 (sub-classing). To model class bar as the subclass of foo:
(1) make Bar inherit from Foo, and override any virtual properties according to the application semantics.
(2) make BarImpl inherit from Bar, but BarImpl can be implemented independently from FooImpl (hence no data dependency of BarImpl on FooImpl).

Rule 5 (add and use new semantic assigning property after branching). If class C is the semantic branching site of property p, in every data-interface class D that is immediate below C:
(1) add a new semantic assigning virtual property p′ (of course, p′ and p are different names),
(2) all other regular methods of D should choose to use p′ instead of p according to the corresponding application semantics when applicable.
   The following is an example of applying this Rule 5:
Class Person is the semantic branching site of property addr.
In class Student, we added a new semantic assigning property dorm( ); and Student.takeRest( ) uses property dorm( ) instead of addr( ).
In class Faculty, we added a new semantic assigning property lab( ); and Faculty.doBenchwork( ) uses property lab( ) instead of addr( ).

In summary: the goal is to make fields joining or separation as flexible as possible, to allow programmers to achieve any intended semantics (in the derived data implementation class) that the application needed:
field joining can be achieved by overriding the corresponding virtual property method of the same name from multiple base classes
field separation can be achieved by implementing/overriding the new semantic assigning property introduced in Rule 5.

```
JAVA WITH INTERFACE DEFAULT METHODS
      Despite many modern programming languages (Java, C#) tried to avoid multiple
      inheritance (MI) by only using single inheritance + multiple interfaces in their initial
      design and releases, to remedy the restrictions due to the lack of MI. they introduced
      various other mechanisms in their later releases, e.g.
          (1) Java v8.0 added default interface methods in 2014 [Oracle 2014]
          (2) C# v8.0 added default interface methods in 2019 [Microsoft 2022])
      Actually, the programming rules we introduced in the previous section works perfect well
      with Java's (>= v8.0) interface default methods, which now allows methods be
      implemented in Java interfaces. In the following, we show how the previous example can
      be coded in Java.
// MI.java
interface Person {
  public String name( ); // abstract property method, to be implemented
  public String addr( ); // abstract property method, to be implemented
  // no actual field
}
class Personlmpl implements Person {
  // only define fields and property methods in data implementation class
  String _name;
  String _addr;
  @Override public String name( ) { return _name; }
  @Override public String addr( ) { return _addr; }
}
/* --------------------------------------------------------------------------- *\
\* --------------------------------------------------------------------------- */
interface Faculty extends Person {
  default String lab( ) {return addr( );} // new semantic assigning property
  // regular methods
  default void doBenchwork( ) {
    System.out.println(name( ) + “ doBenchwork in the ” + lab( ));
  }
}
class Facultylmpl extends Personlmpl implements Faculty {
  // nothing new needed, so just reuse Personlmpl
}
/* --------------------------------------------------------------------------- *\
\* --------------------------------------------------------------------------- */
interface Student extends Person {
  default String dorm( ) {return addr( );} // new semantic assigning property
  // regular methods
  default void takeRest( ) {
    System.out.println(name( ) + “ takeRest in the ” + dorm( ));
  }
}
class Studentlmpl extends Personlmpl implements Student {
  // nothing new needed, so just reuse Personlmpl
}
/* --------------------------------------------------------------------------- *\
\* --------------------------------------------------------------------------- */
interface ResearchAssistant extends Student, Faculty {
  // factory method
  static ResearchAssistant make( ) {
    ResearchAssistant ra = new ResearchAssistantlmpl( );
    return ra;
  }
}
class ResearchAssistantlmpl implements ResearchAssistant {
  // define three fields: NOTE: totally independent to those fields in Personlmpl, Studentlmpl, and
Facultylmpl
  String _name;
  String _faculty_addr;
  String _student_addr;
ResearchAssistantlmpl( ) { // constructor
  _name = “ResAssis”;
  _faculty_addr = “lab”;
  _student_addr = “dorm”;
}
  // property methods
  @Override public String name( ) { return _name; }
  @Override public String addr( ) { return dorm( ); } // use dorm as addr
  @Override public String dorm( ) { return _student_addr; }
  @Override public String lab( ) { return _faculty_addr; }
}
/* --------------------------------------------------------------------------- *\
\* --------------------------------------------------------------------------- */
public class MI {
  public static void main(String[ ] args) {
    ResearchAssistant ra = ResearchAssistant.make( );
    Faculty f = ra;
    Student s = ra;
    ra.doBenchwork( ); // ResAssis doBenchwork in the lab
    ra.takeRest( ); // ResAssis takeRest in the dorm
    f.doBenchwork( ); // ResAssis doBenchwork in the lab
    s.takeRest( ); // ResAssis takeRest in the dorm
  }
}
```

Programming paradigms evolution: procedural, OOP, DDIFI

In the following, we compare three different ways of programming using C++:
(1) Procedural programming, where data and functions are separate.
(2) Object oriented programming (OOP), where data and methods are bundled together in one unit (class).
(3) OOP with Decoupling Data Interface From data Implementation (DDIFI), where each class is split into a data-interface class and a data-implementation class.

### Procedural Programming

```
struct Person {
  String name;
  String addr;
};
void a function(Person* p) {
  print(p->addr);
}
```

### Object Oriented Programming

```
class Person {
  String name;
  String addr;
public:
  void a_regular_method( ) { print(this->addr); }
};
```

### OOP with DDIFI

```
class Person {
public:
  virtual String name( ) = 0;
  virtual String addr( ) = 0;
  void a_regular_method( ) { print(this->addr( ); }
};
class Personlmpl : Person {
private:
  String _name;
  String _addr;
public:
  virtual String name( ) { return _name; }
  virtual String addr( ) { return _addr; }
};
```

Reference to other academic publications:
(1) Kim Barrett, Bob Cassels, Paul Haahr, David A. Moon, Keith Playford, and P. Tucker Withington. 1996.
(2) A Monotonic Superclass Linearization for Dylan. OOPSLA '96 Conference Proceedings. ACM Press. (1996), 69-82.
(3) Gilad Bracha and William Cook. 1990. Mixin-based inheritance. OOPSLA/ECOOP '90: Proceedings of the European conference on object-oriented programming on Object-oriented programming systems, languages, and applications (1990), 303-311.
(4) Walter Bright, Andrei Alexandrescu, and Michael Parker. 2020. Origins of the D Programming Language. Proceedings of the ACM on Programming Languages, Volume 4, Issue HOPL (June 2020), 1-38.
(5) Martin Büchi and Wolfgang Weck. 2000. Generic wrappers. In ECOOP 2000 Object-Oriented Programming: 14th European Conference Sophia Antipolis and Cannes, France, Jun. 12-16, 2000 Proceedings 14. Springer, 201-225.
(6) Stéphane Ducasse, Oscar Nierstrasz, Nathanael Schärli, Roel Wuyts, and Andrew P Black. 2006. Traits: A mechanism for fine-grained reuse. ACM Transactions on Programming Languages and Systems (TOPLAS) 28, 2 (2006), 331-388.
(7) David Flanagan and Yukihiro Matsumoto. 2008. The Ruby Programming Language: Everything You Need to Know. O'Reilly Media, Inc.
(8) Google. Jul. 5, 2022. Google C++ Style Guide. https://google.github.io/styleguide/cppguide.html
(9) James Gosling, Bill Joy, Guy Steele, and Gilad Bracha. 2000. The Java language specification. Addison-Wesley Professional.
(10) Anders Hejlsberg, Scott Wiltamuth, and Peter Golde. 2003. C # language specification. Addison-Wesley Longman Publishing Co., Inc.
(11) Günter Kniesel. 1999. Type-safe delegation for run-time component adaptation. In ECOOP99 Object-Oriented Programming: 13th European Conference Lisbon, Portugal, Jun. 14-18, 1999 Proceedings 13. Springer, 351-366.
(12) Jørgen Lindskov Knudsen. 1988. Name collision in multiple classification hierarchies. In European Conference on Object-Oriented Programming. Springer, 93-109.
(13) Xavier Leroy, Damien Doligez, Alain Frisch, Jacques Garrigue, Didier Rémy, and Jérôme Vouillon. 2021.
(14) The OCaml system release 4.13: Documentation and user's manual. Ph. D. Dissertation. Inria.
(15) Josh Lockhart. 2015. Modern PHP: New features and good practices. O'Reilly Media, Inc.
(16) Donna Malayeri and Jonathan Aldrich. 2009. CZ: multiple inheritance without diamonds. ACM SIGPLAN Notices 44, 10 (2009), 21-40.
(17) Bertrand Meyer. 1993. Eiffel: The Language. Prentice Hall. http://www.inf.ethz.ch/˜meyer/ongoing/etl
(18) S. Meyers. 1995. More Effective C++. Addison-Wesley, New York.
(19) Microsoft. Aug. 12, 2022. Default interface methods. https://learn.microsoft.com/en-us/dotnet/csharp/language-reference/proposals/csharp-8.0/default-interface-methods
(20) Martin Odersky. 2010. The Scala language specification, version 2.9. EPFL (May 2011) (2010).
(21) Oracle. 2014. Default Methods. https://docs.oracle.com/javase/tutorial/java/landl/defaultmethods.html
(22) Guilherme Ottoni. 2018. HHVM JIT: A Profile-guided, Region-based Compiler for PHP and Hack. In Pro-ceedings of the 39th ACM SIGPLAN Conference on Programming Language Design and Implementation. 151-165.
(23) M Sakkinen. 1989. Disciplined Inheritance. In ECOOP 89. Cambridge University Press, 39-56.
(24) Nathanael Schärli, Stéphane Ducasse, Oscar Nierstrasz, and Andrew P. Black. 2003. Traits: Composable Units of Behaviour. Lecture Notes in Computer Science 2743 (2003), 248-274.
(25) Alan Snyder. 1987. Inheritance and the development of encapsulated software components. In Research Directions in Object-Oriented Programming, Series in Computer Systems, Bruce Shriver and Peter Wegner (Eds.). The MIT Press, 165-188.
(26) Guy Steele. 1990. Common LISP: the language. Elsevier.
(27) Bjarne Stroustrup. 1989c. Multiple inheritance for C++. Computing Systems 2, 4 (1989), 367-395.
(28) Bjarne Stroustrup. 1991. The C++ Programming Language (Second Edition). Addison-Wesley.
(29) B Stroustrup. 1994. The Design and Evolution of C++. Addison Weasley. Reading (1994).
(30) Bjarne Stroustrup. 2003. The C++ Standard: Incorporating Technical Corrigendum No. 1.
(31) Pablo Tesone, Stéphane Ducasse, Guillermo Polito, Luc Fabresse, and Noury Bouraqadi. 2020. A new modular implementation for stateful traits. Science of Computer Programming 195 (2020).
(32) Eddy Truyen, Wouter Joosen, Bo Nørregaard Jørgensen, and Pierre Verbaeten. 2004. A generalization and solution to the common ancestor dilemma problem in delegation-based object systems. In Dynamic aspects workshop (daw04), Vol. 6.
(33) Guido van Rossum. Jun. 23, 2010. The History of Python: Method Resolution Order. https://python-history.blogspot.com/2010/06/method-resolution-order.html
(34) Guido Van Rossum and Fred L Drake Jr. 2014. The python language reference. Python Software Foundation: Wilmington, DE, USA (2014).
(35) Daniel Wasserrab, Tobias Nipkow, Gregor Snelting, and Frank Tip. 2006. An operational semantics and type safety proof for multiple inheritance in c++. In Proceedings of the 21st annual ACM SIGPLAN conference on Object-oriented programming systems, languages, and applications. 345-362.

1. A method for achieving clean multiple inheritance in object oriented programming, wherein the programmers can specify on an individual bases whether each of the inherited data fields should be joined or separated in the sub-classes, when applied to the OOP languages that support native multiple inheritance (such as C++, Python, Ocaml, Lisp, and Eiffel, etc.), the method compromising the following implementation steps:
a. for each class the programmers want to model, split into two classes, the first is its data interface class and the second is its data implementation class, and:
i. the data interface class only defines the abstract virtual accessor/property methods for each of the class' fields but does not define the raw data fields themselves, and defines other concrete regular methods using these abstract virtual property methods; and
ii. the data implementation class inherits the data interface class, defines the actual data fields, and overrides or implements the concrete virtual property methods using these actual fields, or using computation instead of raw data fields; and
iii. define one or more factory methods, which create an object of the type of the data implementation class and return it as the type of the data interface class; the said factory methods can be defined as global free functions, or as the data interface class' static member functions; and
b. for each sub-class:
i. its data interface class inherits from its (multiple) super-classes' data interface classes, and can optionally choose to overrides any of the inherited virtual properties depending on the computer program's application semantics; and
ii. implement the sub-class's data implementation class independently from its super-classes' data implementation classes, wherein it can still optionally inherit from one of more its super-classes' data implementation classes, but it is not mandated to do so; and
c. for each field that is semantically branched [0018 Definition 2]:
i. in each data interface class of the sub-class that is immediately below the semantic branching site [0018 Definition 2], introduce a new abstract semantic assigning property, which use a different name from its original field name; and
ii. each regular method in the sub-class' data interface class can optionally choose to use the said new semantic assigning property introduced in the previous step (1.c.i) depending on the computer program's application semantics.

2. The method of claim 1, when applied in OOP languages that does not support native multiple inheritance but support default interface methods (such as Java, C #, etc.), compromising:
a. define the data interface class of claim 1.a.i as the interface in these languages,
b. each sub-class inherit from its (multiple) super-classes' data interfaces.

3. The method of claim 1, when applied in OOP languages that does not support native multiple inheritance and default interface methods, but support trait (such as Scala, etc.), compromising:
a. define the data interface class of claim 1.a.i as the trait in these languages,
b. each sub-class inherit from its (multiple) super-classes' data traits.

4. The method of claim 1, wherein each step is implemented as compiler (or interpreter) rules of any OOP languages that support native multiple inheritance (such as C++, Python, Ocaml, Lisp, and Eiffel, etc.) to report any violations in the source code to the programmers.

5. The method of claim 1, wherein each step is implemented as rules in the static source code analysis tool (e.g. just like lint for C) of any OOP languages that support native multiple inheritance (such as C++, Python, Ocaml, Lisp, and Eiffel, etc.) to report any violations in the source code to the programmers.

6. The method of claim 2, wherein each step is implemented as compiler (or interpreter) rules of any OOP languages that does not support native multiple inheritance but support default interface methods (such as Java, C #, etc.) to report any violations in the source code to the programmers.

7. The method of claim 2, wherein each step is implemented as rules in the static source code analysis tool (e.g. just like lint for C) of any OOP languages that does not support native multiple inheritance but support default interface methods (such as Java, C #, etc.) to report any violations in the source code to the programmers.

8. The method of claim 3, wherein each step is implemented as compiler (or interpreter) rules of any OOP languages that does not support native multiple inheritance and default interface methods, but support trait (such as Scala, etc.) to report any violations in the source code to the programmers.

9. The method of claim 3, wherein each step is implemented as rules in the static source code analysis tool (e.g. just like lint for C) of any OOP languages that does not support native multiple inheritance and default interface methods, but support trait (such as Scala, etc.) to report any violations in the source code to the programmers.
